(19) United States
(12) Patent Application Publication
(10) Pub. No.: US 2013/0027520 A1
(43) Pub. Date: Jan. 31, 2013

(54) 3D IMAGE RECORDING DEVICE AND 3D IMAGE SIGNAL PROCESSING DEVICE

(71) Applicants: Hiromichi Ono, Hyogo (JP); Haruo Yamashita, Osaka (JP); Takeshi Ito, Osaka (JP)

(72) Inventors: Hiromichi Ono, Hyogo (JP); Haruo Yamashita, Osaka (JP); Takeshi Ito, Osaka (JP)

(21) Appl. No.: 13/640,603

(22) PCT Filed: Apr. 19, 2011
(86) PCT No.: PCT/JP2011/002284

§ 371 Date: Oct. 11, 2012

(30) Foreign Application Priority Data
Apr. 20, 2010 (JP) 2010-096803

(51) Int. Cl. G06T 5/00; H04N 13/02

(52) U.S. Cl. 348/46; 382/154; 348/E13.074

(57) ABSTRACT

A 3D image signal processing device performs a signal processing on at least one image signal of a first viewpoint signal as an image signal generated at a first viewpoint and a second viewpoint signal as an image signal generated at a second viewpoint different from the first viewpoint. The device includes an image processor that executes a predetermined image processing on at least one image signal of the first viewpoint signal and the second viewpoint signal, and a controller that controls the image processor. The controller controls the image processor to perform an feathering process on at least one image signal of the first viewpoint signal and the second viewpoint signal, the feathering process being a process for smoothing pixel values of pixels positioned on a boundary between an object included in the image represented by the at least one image signal and an image adjacent to the object.

### TECHNICAL FIELD

The present invention relates to a device for recording a 3D image signal or a device for reproducing a 3D image signal.

### BACKGROUND ART

There are known techniques to reproduce a 3D image by displaying right and left images captured with binocular parallax through a display device that enables right and left eyes to independently view the right and left images. As a general method for capturing right and left images, there is a known method for operating two cameras arranged laterally in synchronization with each other to record right and left images. In another method, subject images formed by two optical systems at different viewpoints are captured with a single imaging device, which are then recorded.

The 3D image signal recorded in the above method is subject to an image processing so that an optimum image can be visually recognized when it is reproduced as a 2D image signal. For this reason, when this image signal is reproduced as a 3D image signal, a signal processing (hereinafter, “3D image processing”) that is suitable for 3D reproduction should be executed on the image signal.

As the conventional 3D image processing, Patent Document 1 proposes that a process for enhancing an edge of a subject is strengthened more as the subject is nearer to a viewer according to an amount of binocular parallax. Further, Patent Document 2 discloses that a left-eye image display screen and a right-eye image display screen are arranged so as to have a convergence angle that does not cause contradiction with respect to a distance from a viewer to the screens, and an feathering process is executed on strength determined according to a level of relative shift of corresponding pixels between the left-eye image and the right-eye image. Further, Patent Document 3 discloses the control of visibility of an outline of an image to be higher for a near view and to be lower for a distant view. The near view means a subject arranged near a viewer at a time of viewing an image signal, and the distant view means a subject arranged far from the viewer at a time of viewing the image signal.

### PRIOR ART DOCUMENTS

### Patent Documents

Patent Document 1: JP 11-127456 A
Patent Document 2: JP 06-194602 A
Patent Document 3: JP 11-239364 A

### DISCLOSURE OF INVENTION

### Problem to be Solved by the Invention

The above Patent Documents 1 to 3 disclose the technique that adjusts stereoscopic effect on an image signal obtained by two-dimensional image-capturing, when performing 3D reproduction of the image signal. That is to say, they disclose that an image processing is executed so that the viewer can visibly recognize the near view more clearly but can visibly recognize the distant view more indistinctly.

However, when an image signal, that is subject to the edge enhancing process or the outline enhancing process so that the viewer easily and visibly recognizes the stereoscopic effect, is reproduced three dimensionally, only adjustment of the stereoscopic effect makes the viewer feel unnatural stereoscopic effect. Further, such image processing might cause so-called “cardboard cut-out phenomenon”.

The present invention is devised in order to solve the above problem, and its object is to provide a device and a method for reducing the cardboard cut-out effect caused at the time of reproducing 3D images, and generating or reproducing a 3D image signal enabling more natural stereoscopic effect to be reproduced.

### Means for Solving the Problem

In a first aspect, a 3D image signal processing device is provided, which performs a signal processing on at least one image signal of a first viewpoint signal as an image signal generated at a first viewpoint and a second viewpoint signal as an image signal generated at a second viewpoint different from the first viewpoint. The device includes an image processor that executes a predetermined image processing on at least one image signal of the first viewpoint signal and the second viewpoint signal, and a controller that controls the image processor. The controller controls the image processor to perform an feathering process on at least one image signal of the first viewpoint signal and the second viewpoint signal, the feathering process being a process for smoothing pixel values of pixels positioned on a boundary between an object included in the image represented by the at least one image signal and an image adjacent to the object.

In a second aspect, a 3D image recording device is provided, which captures a subject to generate a first viewpoint signal and a second viewpoint signal. The device includes a first optical system that forms a subject image at a first viewpoint, a second optical system that forms a subject image at a second viewpoint different from the first viewpoint, an imaging unit that generates the first viewpoint signal from the subject image at the first viewpoint and the second viewpoint signal from the subject image at the second viewpoint, an enhancing processor that performs an enhancing process on the first viewpoint signal and the second viewpoint signal, a recording unit that records the first viewpoint signal and the second viewpoint signal that are subject to the enhancing process in a recording medium, and a controller that controls the enhancing processor and the recording unit. The controller controls the enhancing processor so that strength of the enhancing process in a case where the first viewpoint signal and the second viewpoint signal are generated as 3D image signal is weaker than strength in a case where those signals are generated as 2D image signal.

In a third aspect, a 3D image recording device is provided, which captures a subject to generate a first viewpoint signal and a second viewpoint signal. The device includes a first optical system that forms a subject image at a first viewpoint, a second optical system that forms a subject image at a second viewpoint different from the first viewpoint, an imaging unit that generates the first viewpoint signal from the subject image at the first viewpoint and the second viewpoint signal from the subject image at the second viewpoint, a parallax amount obtaining unit that obtains an amount of parallax between a image represented by the first viewpoint signal and a image represented by the second viewpoint signal for each of sub-regions, the sub-regions being obtained by dividing a region of the image represented by at least one image signal of the first viewpoint signal and the second viewpoint signal, an enhancing processor that performs an enhancing process on the first viewpoint signal and the second viewpoint signal, a recording unit that records the first viewpoint signal and the second viewpoint signal that are subject to the enhancing process in a recording medium, and a controller that controls the enhancing processor and the recording unit. When the first viewpoint signal and the second viewpoint signal are generated as 3D image signal, the controller controls the enhancing processor to perform the enhancing process on pixels other than pixels positioned on a boundary between one sub-region and another sub-region adjacent to the one sub-region according to a difference between the amount of parallax detected on the one sub-region and an amount of parallax detected on the another sub-region.

In a fourth aspect, a 3D image signal processing method is provided, which performs a signal processing on at least one image signal of a first viewpoint signal as an image signal generated at a first viewpoint and a second viewpoint signal as an image signal generated at a second viewpoint different from the first viewpoint. The method includes performing, on at least one image signal of the first viewpoint signal and the second viewpoint signal, a process for smoothing pixel values of pixels positioned on a boundary between an object included in the image represented by the at least one image signal and an image adjacent to the object.

In a fifth aspect, a 3D image recording method is provided, which records a first viewpoint signal and a second viewpoint signal generated by capturing a subject in a recording medium. The method includes generating the first viewpoint signal from a subject image at a first viewpoint, and generating the second viewpoint signal from a subject image at a second viewpoint different from the first viewpoint, performing an enhancing process on the first viewpoint signal and the second viewpoint signal, and recording the first viewpoint signal and the second viewpoint signal that are subject to the enhancing process in the recording medium. In the enhancing process, strength of the enhancing process in a case where the first viewpoint signal and the second viewpoint signal are generated as 3D image signal is weaker than strength in a case where those signals are generated as 2D image signal.

In a sixth aspect, a 3D image recording method is provided, which records a first viewpoint signal and a second viewpoint signal generated by capturing a subject in a recording medium. The method includes generating the first viewpoint signal from a subject image at a first viewpoint and the second viewpoint signal from a subject image at a second viewpoint different from the first viewpoint, performing an enhancing process on the first viewpoint signal and the second viewpoint signal, and recording the first viewpoint signal and the second viewpoint signal that are subject to the enhancing process in the recording medium, and obtaining an amount of parallax between a image represented by the first viewpoint signal and a image represented by the second viewpoint signal for each of sub-regions, the sub-regions being obtained by dividing a region of the image represented by at least one image signal of the first viewpoint signal and the second viewpoint signal. When the first viewpoint signal and the second viewpoint signal are generated as 3D image signal, the enhancing process is applied on pixels other than pixels positioned on a boundary between one sub-region and another sub-region adjacent to the one sub-region according to a difference between the amount of parallax detected on the one sub-region and an amount of parallax detected on the another sub-region.

### Effect of the Invention

According to the present invention, the image processing that does not enhance an edge is executed on a boundary portion of an image region (object) at which a difference in a distance in a depth direction is to occur when an image signal is 3D-reproduced at a time of recording or 3D-reproducing of the image signal. As a result, a 3D image signal that can reproduce natural stereoscopic effect.

### BRIEF DESCRIPTION OF DRAWINGS

FIG. 1 is a diagram illustrating a configuration of a digital camera according to a first embodiment;

FIG. 2 is a flowchart illustrating an operation for capturing an image signal in a digital camera;

FIG. 3 is a flowchart illustrating an enhancing process;

FIG. 4 is a diagram for describing detection of an amount of parallax by an image processor;

FIG. 5 is a diagram for describing an amount of parallax in each of sub-regions detected by the image processor based on an image of a first viewpoint signal shown in FIG. 4;

FIG. 6 is a diagram illustrating a region 701 in FIG. 5, with the region enlarged;

FIG. 7 is a flowchart illustrating an operation for recording the image signal by the digital camera;

FIG. 8 is a flowchart illustrating an operation for recording the image signal to which a step of detecting flag information is added;

FIG. 9 is a diagram for describing a method for setting a filter size based on the amount of parallax;

FIG. 10 is a diagram describing a low-pass filter;

FIG. 11 is a diagram for describing an operation for setting the filter size in the image processor;

FIG. 12 is a diagram for describing another operation for setting the filter size in the image processor; and

FIG. 13 is a diagram illustrating a configuration of a digital camera according to a second embodiment.

### MODE FOR CARRYING OUT THE INVENTION

Embodiments of the present invention will be described below with reference to the accompanying drawings according to the following procedures.

### <Table of Contents>

1. First Embodiment
1-1. Configuration of Digital Camera
1-2. Operation for Recording Image Signal
   1-2-1. Enhancing Process in Image processing of 3D Shooting Mode (Example 1)
   1-2-2. Enhancing Process in Image processing of 3D Shooting Mode (Example 2)
1-3. Operation for Reproducing (Displaying) Image Signal
   1-3-1. Another Example of the Operation for Reproducing (Displaying) Image Signal
   1-3-2. Feathering Process
      1-3-2-1. Setting of Filter Coefficient and Filter Size of Low-Pass Filter
      1-3-2-2. Setting of Filter Size based on Correlation in Vertical Direction and Horizontal Direction
1-4. Conclusion
1-5. With Regard to Acquisition of Amount of Parallax in Image processor 160

2. Second Embodiment

3. Other Embodiment

### 1. First Embodiment

The first embodiment where the present invention is applied to a digital camera will be described below with reference to the drawings. The digital camera described below is one example of a 3D image signal processing device and a 3D image recording device.

### 1-1. Configuration of Digital Camera

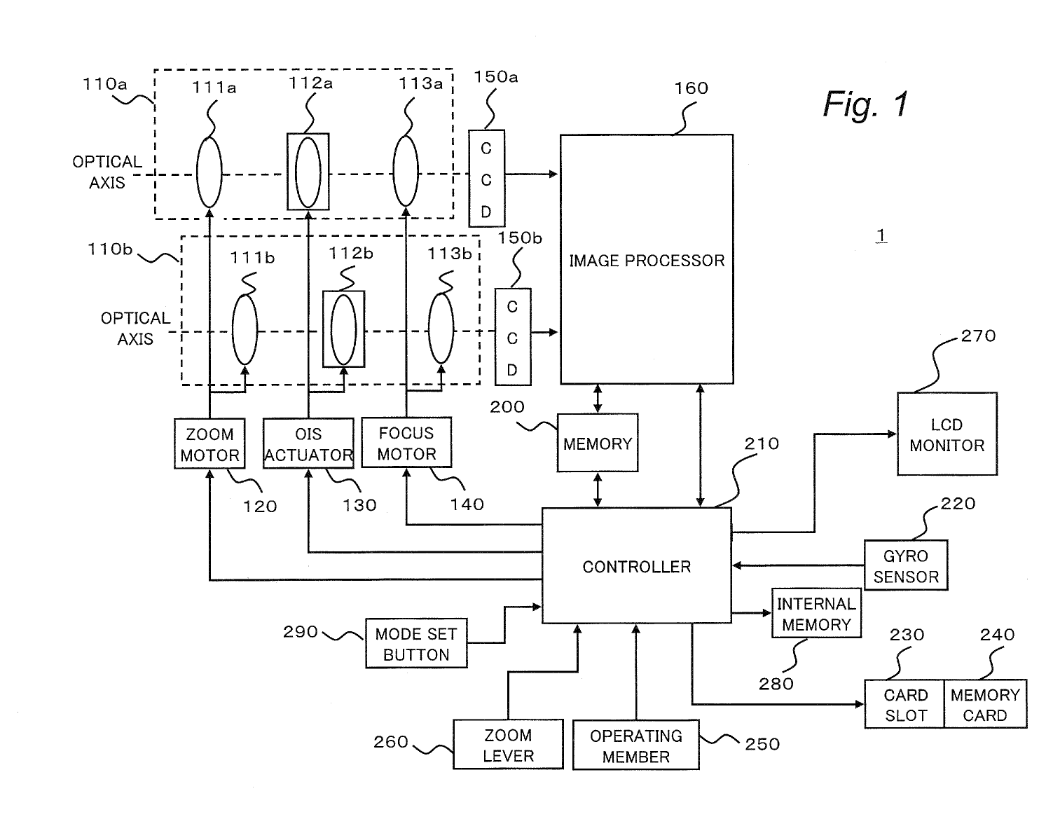

An electric configuration of the digital camera 1 according to this embodiment will be described below with reference to FIG. 1. The digital camera 1 has two optical systems 110a and 110b, CCD image sensors 150a and 150b that are provided correspondingly to the optical systems 110a and 110b, an image processor 160, a memory 200, a controller 210, a gyro sensor 220, a card slot 230, an operating member 250, a zoom lever 260, a liquid crystal monitor 270, an internal memory 280, and a mode setting button 290. The digital camera 1 further includes a zoom motor 120, an OIS actuator 130 and a focus motor 140 for driving optical members included in the optical systems 110a and 110b.

The optical system 110a includes a zoom lens 111a, an OIS (Optical Image Stabilizer) 112a, and a focus lens 113a. Similarly, the optical system 110b includes a zoom lens 111b, an OIS 112b, and a focus lens 113b. The optical system 110a forms a subject image at a first viewpoint (for example, left eye), and the optical system 110b forms a subject image at a second viewpoint different from the first viewpoint (for example, right eye).

The zoom lenses 111a and 111b move along an optical axis of the optical system so as to enable enlarging or reducing of a subject image. The zoom lenses 111a and 111b are driven by the zoom motor 120.

Each of the OISs 112a and 112b contains inside a correction lens that can move in a plane vertical to the optical axis. Each of the OISs 112a and 112b moves the correction lens to a direction to cancel camera shake of the digital camera 1, so as to reduce blur of a subject image. The correction lens can maximally move from the center by L in each of the OISs 112a and 112b. The OISs 112a and 112b are driven by the OIS actuator 130.

Each of the focus lenses 113a and 113b moves along the optical axis of the optical system to adjust a focus of a subject image. The focus lenses 113a and 113b are driven by the focus motor 140.

The zoom motor 120 drives the zoom lens 111a and 111b. The zoom motor 130 may be realized by a pulse motor, a DC motor, a linear motor, a servo motor, or the like. The zoom motor 130 may drive the zoom lenses 111a and 111b via a mechanism such as a cam or a ball screw. Further, the zoom lens 111a and the zoom lens 111b may be configured to be controlled by the same operation.

The OIS actuator 130 drives the correction lens in the OISs 112a and 112b in the plane vertical to the optical axis. The OIS actuator 130 can be realized by a planar coil or an ultrasonic motor.

The focus motor 140 drives the focus lenses 113a and 113b. The focus motor 140 may be realized by a pulse motor, a DC motor, a linear motor, a servo motor, or the like. The focus motor 140 may drive the focus lenses 113a and 113b via a mechanism such as a cam or a ball screw.

The CCD image sensors 150a and 150b capture subject images formed by the optical systems 110a and 110b to generate a first viewpoint signal and a second viewpoint signal. The CCD image sensors 150a and 150b perform various operations such as exposure, transfer and electronic shutter. In this embodiment, the images represented by the first viewpoint signal and the second viewpoint signal are still images, but even in a case of moving images, the processes according to the embodiment described below can be applied to images at each frame of a moving image.

The image processor 160 executes various processes on the first viewpoint signal and the second viewpoint signal generated by the CCD image sensors 150a and 150b, respectively. The image processor 160 executes the processes on the first viewpoint signal and the second viewpoint signal, to generate image data to be displayed on the liquid crystal monitor 270 (hereinafter, “review image”), and generate an image signal to be stored in a memory card 240. For example, the image processor 160 executes various image processing such as gamma correction, white balance correction and scratch correction on the first viewpoint signal and the second viewpoint signal.

Further, the image processor 160 executes enhancing process such as an edge enhancing process, contrast enhancing and a super-resolution process on the first viewpoint signal and the second viewpoint signal based on control signals from the controller 210. A detailed operation of the enhancing process will be described later.

Further, the image processor 160 executes an feathering process on at least one image signal of the first viewpoint signal and the second viewpoint signal read from the memory card 240 based on a control signal from the controller 210. The feathering process is an image processing for causing an image to be viewed indistinctly, namely, for preventing a difference among the pixels from being clearly recognized at a time of visually recognizing of an image based on an image signal. For example, the feathering process is a process for smoothing a pixel value of pixel data represented by an image signal in a manner that a high-frequency component of image data represented by the image signal is removed. The feathering process is not limited to the above described configuration, and any process may be used as long as it is the image processing for preventing a viewer from clearly recognizing a difference among the pixels at the time when the viewer visually recognizes an image signal. A detailed operation of the feathering process in the image processor 160 will be described later.

Further, the image processor 160 executes a compressing process on the processed first and second viewpoint signals in a compressing system based on JPEG standards, respectively. The compressed image signals that are obtained by compressing the first viewpoint signal and the second viewpoint signal, respectively, are related to each other, and are recorded in the memory card 240. In this case, it is desirable that recording is carried out by using an MPO file format. Further, when an image signal to be compressed is a moving image, moving image compressing standards such as H.264/AVC are employed. Further, the embodiment may be arranged such that the MPO file format, and a JPEG image or an MPEG moving image are recorded simultaneously.

The image processor 160 can be realized by a DSP (Digital Signal Processor) or a microcomputer. Resolution of a review image may be set to screen resolution of the liquid crystal monitor 270 or resolution of image data compressed and formed according to the compressing format based on the JPEG standard.

The memory 200 functions as work memories of the image processor 160 and the controller 210. The memory 200 temporarily stores, for example, image signals processed by the image processor 160 or image data input from the CCD image sensor 150 before the process by the image processor 160. Further, the memory 200 temporarily stores shooting conditions of the optical systems 110a and 110b, and the CCD image sensors 150a and 150b at a time of shooting. The shooting conditions represent a subject distance, view angle information, an ISO speed, a shutter speed, an EV value, an F value, an inter-lens distance, a shooting time, and an OIS shift amount. The memory 200 can be realized by, for example, a DRAM and a ferroelectric memory.

The controller 210 is a control unit for controlling an entire operation of the digital camera 1. The controller 210 can be realized by a semiconductor device. The controller 210 may be composed of only hardware or a combination of hardware and software. For example, the controller 210 can be realized by a microcomputer.

The gyro sensor 220 is composed of a vibrated member such as a piezoelectric element. The gyro sensor 220 vibrates the vibrated member such as a piezoelectric element at a constant frequency, converts a force obtained by Coriolis force into a voltage so as to obtain angular speed information according to the vibration. A camera shake to be given to the digital camera 100 by the user is corrected by obtaining the angular speed information from the gyro sensor 220 and driving the correction lens to a direction to cancel the vibration according to this angular speed information. The gyro sensor 220 may be at least a device that can measure angular speed information about a pitch angle. Further, when the gyro sensor 220 can measure angular speed information about a roll angle, rotation of the digital camera 1 caused by motion to an approximately horizontal direction can be taken into consideration.

The memory card 240 can be attached to/detached from the card slot 230. The card slot 230 can be mechanically and electrically connected to the memory card 240.

The memory card 240 contains a flash memory or a ferroelectric memory, and can store data.

The operating member 250 includes a release button. The release button receives a pressing operation from the user. When the release button is half-pressed, automatic focal point (F) control and automatic exposure (AE) control are started via the controller 210. Further, when the release button is full-pressed, the operation for shooting a subject is started.

The zoom lever 260 is a member for receiving an instruction for changing zoom magnification from the user.

The liquid crystal monitor 270 is a display device that can two-dimensionally or three-dimensionally display the first viewpoint signal or the second viewpoint signal generated by the CCD image sensor 150a or 150b, and the first viewpoint signal and the second viewpoint signal read from the memory card 240. Further, the liquid crystal monitor 270 can display various setting information about the digital camera 100. For example, the liquid crystal monitor 270 can display an EV value, an F value, a shutter speed and an ISO speed as the shooting conditions at the time of shooting.

In the case of 2D display, the liquid crystal monitor 270 may select any one of the first viewpoint signal and the second viewpoint signal, and display a image based on the selected signal, or may display the images based on the first viewpoint signal and the second viewpoint signal on screens that are separated right and left or up and down, respectively. In another manner, the images based on the first viewpoint signal and the second viewpoint signal may be displayed alternatively on each line.

On the other hand, in the case of 3D display, the liquid crystal monitor 270 may display the images based on the first viewpoint signal and the second viewpoint signal in a frame sequential manner, or may display the images based on the first viewpoint signal and the second viewpoint signal in an overlaid manner.

The internal memory 280 is composed of a flash memory or a ferroelectric low memory. The internal memory 280 stores a control program for entirely controlling the digital camera 1.

The mode setting button 290 is a button for setting a shooting mode at a time of shooting an image with the digital camera 1. “The shooting mode” is a mode for a shooting operation according to a shooting scene which is assumed by the user, and includes, for example, a 2D shooting mode and a 3D shooting mode. The 2D shooting mode includes, for example, (1) a person mode, (2) a child mode, (3) a pet mode, (4) a macro mode and (5) a scenery mode. The 3D shooting mode may be provided for the respective modes (1) to (5). The digital camera 1 sets suitable shooting parameters according to the set shooting mode so as to carry out the shooting. The digital camera 1 may include a camera automatic setting mode for performing automatic setting. Further, the mode setting button 290 is a button for setting a reproducing mode for an image signal to be recorded in the memory card 240.

### 1-2. Operation for Recording Image Signal

An operation for recording an image signal by the digital camera 1 will be described below.

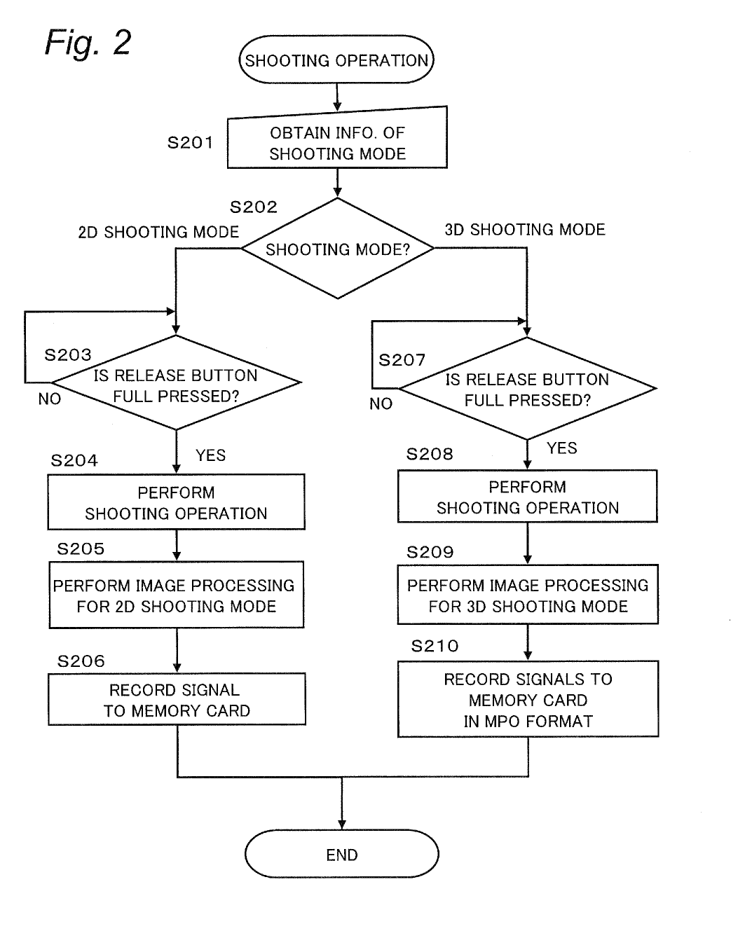

FIG. 2 is a flowchart for describing the operation for shooting an image signal in the digital camera 1. When the mode setting button 290 is operated by the user to set into the shooting mode, the digital camera 1 obtains information about the set shooting mode (S201).

The controller 210 determines whether the obtained shooting mode is the 2D shooting mode or the 3D shooting mode (S202).

When the obtained shooting mode is the 2D shooting mode, the operation in the 2D shooting mode is performed (S203-S206). Concretely, the controller 210 stands by until the release button is full-pressed (S203). When the release button is full-pressed, at least one of the imaging devices of the CCD image sensors 150a and 150b performs the shooting operation based on a shooting condition set in the 2D shooting mode, and generates at least one of the first viewpoint signal and the second viewpoint signal (S204).

When the image signal is generated, the image processor 160 executes the various image processing on the generated image signal according to the 2D shooting mode, and executes the enhancing process to generate a compressed image signal (S205).

When the compressed image signal is generated, the controller 210 records the compressed image signal in the memory card 240 connected to the card slot 230. When the compressed image signal of the first viewpoint signal and the compressed image signal of the second viewpoint signal are obtained, the controller 210 relates the two compressed image signals to each other so as to record them according to, for example, the MPO file format into the memory card 240.

On the other hand, when the obtained shooting mode is the 3D shooting mode, the operation of the 3D shooting mode is performed (S207-S210). Concretely, the controller 210 stands by until the release button is full-pressed similarly to the 2D shooting mode (S207).

When the release button is full-pressed, the CCD image sensors 150a and 150b (imaging device) perform the shooting operation based on the shooting condition set in the 3D shooting mode, and generate the first viewpoint signal and the second viewpoint signal (S208).

When the first viewpoint signal and the second viewpoint signal are generated, the image processor 160 executes the predetermined image processing in the 3D shooting mode, on the two generated image signals (S209). With the predetermined image processing, the two compressed image signals of the first viewpoint signal and the second viewpoint signal are generated. Particularly in the embodiment, in the 3D shooting mode, the enhancing process is not executed but the two compressed image signals of the first viewpoint signal and the second viewpoint signal are generated. Since the enhancing process is not executed, outlines of images to be reproduced by the first viewpoint signal and the second viewpoint signal become more ambiguous than a case where the enhancing process is executed. For this reason, occurrence of unnatural stereoscopic effect such as the cardboard cut-out effect at time of the 3D reproduction can be reduced.

When the two compressed image signals are generated, the controller 210 records the two compressed image signals in the memory card 240 connected to the card slot 230 (S210). At this time, the two compressed image signals are related to each other and recorded in the memory card 240 by using, for example, the MPO file format.

In the above manner, the digital camera 1 according to this embodiment records images in the 2D shooting mode and 3D shooting mode, respectively.

### 1-2-1. Enhancing Process in Image Processing of 3D Shooting Mode

### Example 1

The above describes the example where the enhancing process is not executed in the image processing at step S209, but the enhancing process may be executed. In this case, strength of the enhancing process in the 3D shooting mode is set to be weaker than strength of the enhancing process in the 2D shooting mode. With this method, since the outlines of the images to be reproduced by the first viewpoint signal and the second viewpoint signal captured in the 3D shooting mode become more ambiguous than that in the case of the shooting in the 2D shooting mode. For this reason, occurrence of unnatural stereoscopic effect such as the cardboard cut-out effect at time of the 3D reproduction can be reduced.

### 1-2-2. Enhancing Process in the Image Processing of the 3D Shooting Mode

### Example 2

Further, in the image processing at step S209, when the enhancing process is executed, the image processor 160 may execute the enhancing process only on partial regions (hereinafter, “sub-regions”) of the images represented by the first viewpoint signal and the second viewpoint signal. Hereinafter, an operation of the enhancing process on the sub-regions of the images represented by the image signals executed by the image processor 160 will be described below.

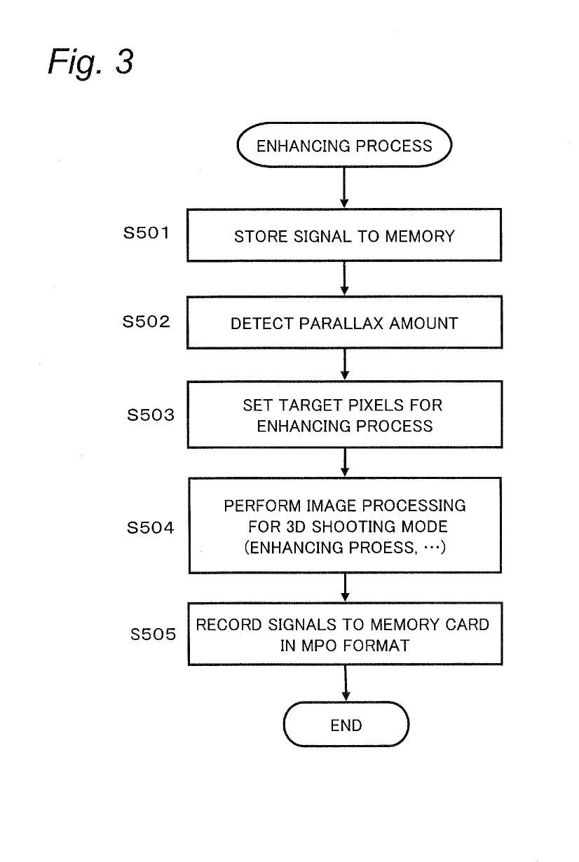

FIG. 3 is a flowchart describing the operation of the enhancing process on the sub-region represented by the image signal.

The image processor 160 temporarily stores the first viewpoint signal and the second viewpoint signal generated by the CCDs 150a and 150b in the memory 200 (S501).

The image processor 160 calculates an amount of parallax of an image represented by the second viewpoint signal to an image represented by the first viewpoint signal based on the first viewpoint signal and the second viewpoint signal stored in the memory 200 (S502). Calculation of the amount of parallax is described here.

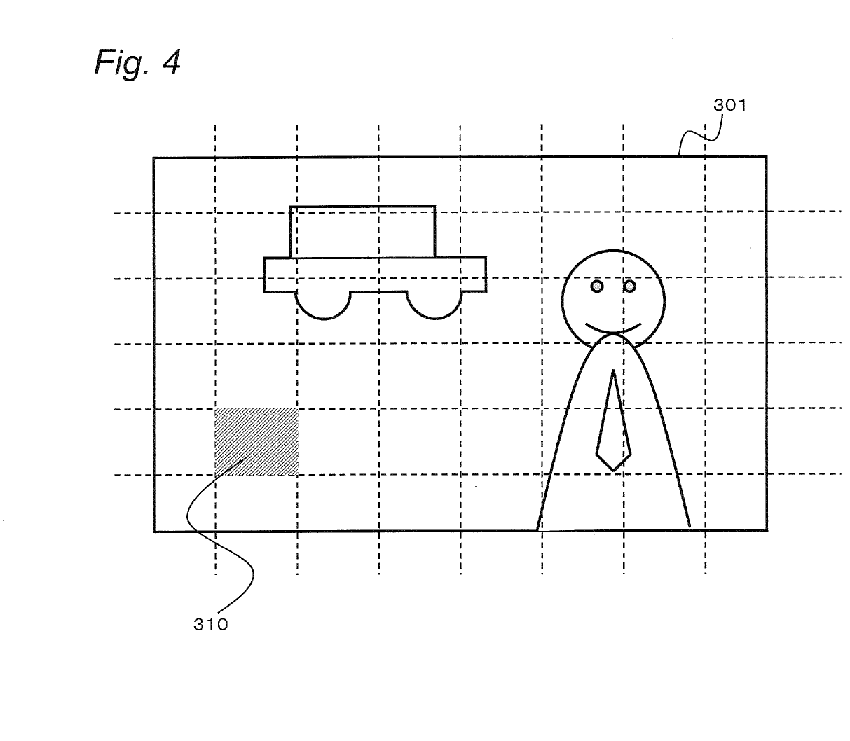

FIG. 4 is a diagram for describing the calculation of the amount of parallax in the image processor 160. As shown in FIG. 4, the image processor 160 divides a whole region of an image 301 represented by the first viewpoint signal read from the memory 200 into a plurality of partial regions, namely, into sub-regions 310, and detects the amount of parallax in each of the sub-regions 310. In an example of FIG. 4, the entire region of the image 301 represented by the first viewpoint signal is divided into the 48 sub-regions 310, but a number of the sub-regions to be set may be suitably set based on an entire processing amount of the digital camera 1. For example, when processing ability is enough for a processing load of the digital camera 1, the number of the sub-regions may be increased. On the other hand, when the processing ability is not enough, the number of the sub-regions may be reduced. More concretely, when the processing ability is not enough, a unit of 16×16 pixels and a unit of 8×8 pixels are set for the sub-regions, and one representative amount of parallax may be detected in each of the sub-regions. On the other hand, when the processing ability of the digital camera 1 is enough, the amount of parallax may be detected for each pixel. That is to say, a size of the sub-regions may be set to 1×1 pixel.

The amount of parallax is, for example, a shift amount in the horizontal direction of the image represented by the second viewpoint signal to the image represented by the first viewpoint signal. The image processor 160 executes a block matching process between the sub-regions represented by the first viewpoint signal and the sub-regions represented by the second viewpoint signal. The image processor 160 calculates the shift amount in the horizontal direction based on a result of the block matching process, and sets the calculated shift amount to the amount of parallax.

Returning to FIG. 3, after detecting the amount of parallax, the image processor 160 sets a plurality of target pixels for the enhancing process as to at least one of the first viewpoint signal and the second viewpoint signal based on the detected amount of parallax (S503).

Particularly in the embodiment, the image processor 160 sets, as target pixels, pixels positioned on a region other than a region where the viewer can recognize a difference in depth at the time of 3D-reproducing the first viewpoint signal and the second viewpoint signal. The region where the difference in depth can be recognized is, for example, a region of a boundary between an object in a near view and a background, or a region of a boundary between an object in a near view and an object in a distant view. That is to say, the region where the difference in depth can be recognized includes pixels positioned near the boundary between the near view and the distant view.

Concretely, when the difference between the amount of parallax detected on one sub-region and the amount of parallax detected on a sub-region adjacent to the one sub-region is larger than a predetermined value, the image processor 160 sets pixels positioned on a boundary portion between the one sub-region and the adjacent sub-region, as target pixels for the enhancing process. The setting of the target pixels for the enhancing process will be concretely described.

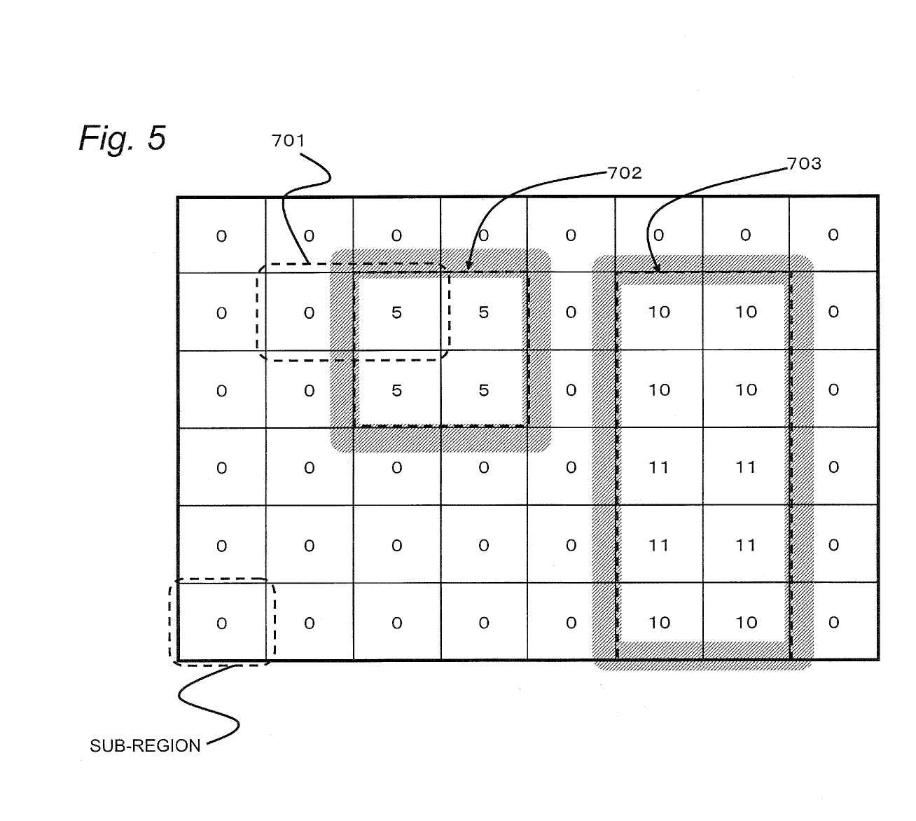

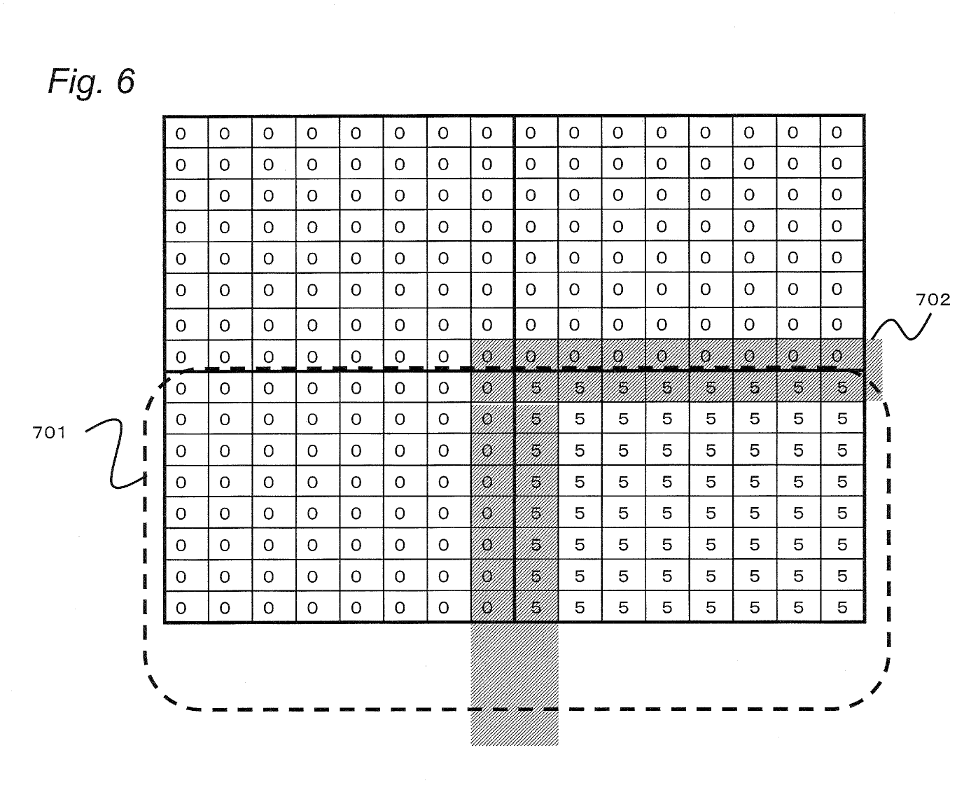

FIG. 5 is a diagram illustrating the amount of parallax detected for each sub-region by the image processor 160 based on the first viewpoint signal shown in FIG. 4. FIG. 6 is a diagram illustrating the region including a region 701 in FIG. 5 with the region being enhanced. The values of the amount of parallax shown in FIGS. 5 and 6 are obtained based on the amount of parallax of an object displayed at the farther end at the time of 3D reproduction. Specifically, the value of the amount of parallax is shown with the amount of parallax of the object displayed at the farther end being 0. When the plurality of sub-regions having the similar amount of parallax are continuously present, the image processor 160 can recognize that the sub-regions compose one object.

When the predetermined value is set to 4, the image processor 160 sets pixels positioned near boundaries between a region 702 shown in FIG. 5 and its adjacent region and between a region 703 and its adjacent region, namely, near the boundaries between the sub-regions, as non-target pixels for the enhancing process. That is to say, the image processor 160 sets the pixels included in the hatching region 702 shown in FIG. 6 as the non-target pixels for the enhancing process. The image processor 160 may set the pixels adjacent to the pixels positioned on the boundary between the sub-regions, as the non-target pixels for the enhancing process. In this case, pixels within a certain range such as within two or three pixels from the boundary between the sub-regions are set as the non-target pixels for the enhancing process. The image processor 160 sets pixels on the region 702 and the region 703 of the object other than the non-target pixels for the enhancing process, as the target pixels for the enhancing process.

Returning to FIG. 3, the image processor 160 executes the various image processing on the first viewpoint signal and the second viewpoint signal, and executes the enhancing process on the target pixels for the enhancing process (namely, the pixels other than the non-target pixels for the enhancing process) so as to generate compressed image signals (S504).

When the compressed image signals are generated, the controller 210 relates the two compressed image signals to each other so as to record them in the memory card 240 connected to the card slot 230. The controller 210 relates the two compressed image signals to each other to record them in the memory card 240 using, for example, the MPO file format (S505).

In this example, the enhancing process is executed on the region of the object (the sub-regions) excluding the pixels on the boundary of the object (the sub-regions). As a result, an outline portion of the object is not enhanced, and thus the viewer can feel more natural stereoscopic effect when performing 3D reproduction of the image signal generated in the 3D shooting mode.

At step S504, the enhancing process may be executed also on non-target pixels. In this case, the strength of the enhancing process to be executed on the non-target pixels is made weaker than that of the enhancing process to be executed on the target pixels. In this case, since the non-target pixels are visually recognized more ambiguous than the target pixels, more natural stereoscopic effect can be expressed.

Further, when the special enhancing process described in this embodiment is executed on the first viewpoint signal or the second viewpoint signal in the 3D shooting mode, flag information representing that the special enhancing process is executed may be stored in a header defined by an MPO format. By referring to this flag at the time of reproduction, it is able to recognize whether the special enhancing process is done.

### 1-3. Operation for Reproducing (Displaying) Image Signal

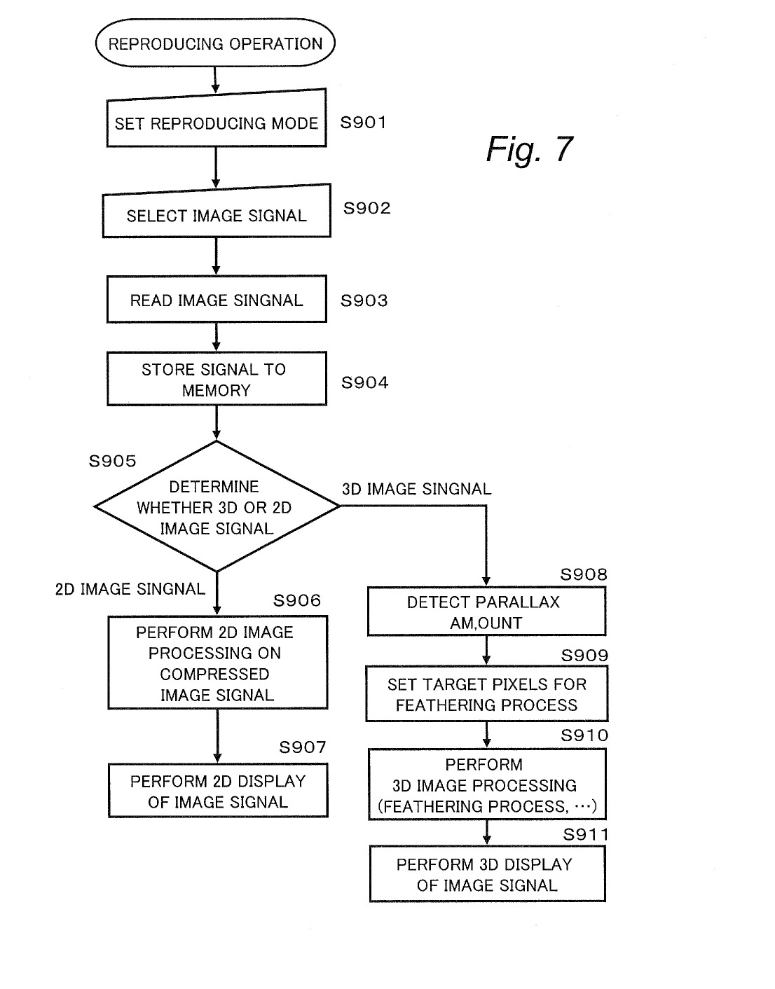

An operation for reproducing a compressed image signal in the digital camera 1 will be described below. FIG. 7 is a flowchart for describing the operation for reproducing a compressed image signal in the digital camera 1.

When the mode setting button 290 is operated by the user to the reproducing mode, the digital camera 1 goes to the reproducing mode (S901).

When the reproducing mode is selected, the controller 210 reads a thumbnail image of an image signal from the memory card 240, or generates a thumbnail image based on the image signal, to display it on the liquid crystal monitor 270. The user refers to the thumbnail image displayed on the liquid crystal monitor 270, and selects an image to be actually displayed via the operating member 250. The controller 210 receives a signal representing the image selected by the user, from the operating member 250 (S902).

The controller 210 reads a compressed image signal relating to the selected image, from the memory card 240 (S903).

When the compressed image signal is read from the memory card 240, the controller 210 temporarily records the read compressed image signal in the memory 200 (S904), and determines whether the read compressed image signal is a 3D image signal or a 2D image signal (S905). For example, when the compressed image signal has the MPO file format, the controller 210 determines that the compressed image signal is the 3D image signal including the first viewpoint signal and the second viewpoint signal. Further, when the user sets whether the 2D image signal is read or the 3D image signal is read in advance, the controller 210 makes a determination based on this setting.

When the determination is made that the read compressed image signal is the 2D image signal, the image processor 160 executes a 2D image processing (S906). As the 2D image processing, concretely, the image processor 160 executes a decoding process of the compressed image processing. As the 2D image processing, the image processing such as a sharpness process and an outline enhancing process may be executed.

After the 2D image processing, the controller 210 performs 2D-display of the image signal subject to the 2D image processing (S907). The 2D display is a display method for displaying on the liquid crystal monitor 270 so that the viewer of the image can visually recognize the image signal as a 2D image.

On the other hand, when the read compressed image signal is determined as the 3D image signal, the image processor 160 calculates the amount of parallax of the image of the first viewpoint signal with respect to the image of the second viewpoint signal based on the first viewpoint signal and the second viewpoint signal recorded in the memory 200 (S908). This operation is similar to the operation at step S502. Hereinafter, for convenience of the description, the image processor 160 detects the amount of parallax for each of the sub-regions which is obtained by dividing the entire region of the image represented by the first viewpoint signal to plural regions.

After the detection of the amount of parallax, the image processor 160 sets a plurality of target pixels for the feathering process in at least any one of the first viewpoint signal and the second viewpoint signal based on the detected amount of parallax. The method for setting target pixels for the feathering process is similar to the method for setting the non-target pixels for the enhancing process described at step S503 in the flowchart of FIG. 3.

Concretely, the image processor 160 sets, as the target pixels for the feathering process, pixels positioned on a region where a viewer can visually recognize a difference in depth when the viewer views the 3D-reproduced images represented by the first viewpoint signal and the second viewpoint signal. The region where a viewer can visually recognize the difference in depth is as described above.

When the difference between the amount of parallax detected on one sub-region and the amount of parallax detected by its adjacent sub-region is larger than a predetermined value, the image processor 160 sets the pixels positioned at the boundary portion between the one sub-region and the another adjacent sub-region, as the target pixels for the feathering process.

After the setting of the target pixels for the feathering process, the image processor 160 executes the 3D image processing on the first viewpoint signal and the second viewpoint signal (S910). As the 3D image processing, concretely, the image processor 160 executes the decoding process of the compressed image processing, and executes the feathering process on the target pixels.

For example, the image processor 160 executes the feathering process using a low-pass filter. More concretely, the image processor 160 executes a filter process on the set target pixels using a low-pass filter having any preset filter coefficient and filter size.

A process corresponding to the feathering process may be executed at the time of the decoding process. For example, in a case of a decoding system using a quantization table of JPEG, quantization of the high-frequency component may be made to be rough, so that the process corresponding to the feathering process may be executed.

The controller 210 performs 3D display of the images based on the first viewpoint signal and the second viewpoint signal that are subject to the decoding process and the feathering process, on the liquid crystal monitor 270 (S911). The 3D display is a display method for displaying the image on the liquid crystal monitor 270 so that the viewer can visually recognize the image signal as a 3D image. As the 3D display method, there is a method for displaying the first viewpoint signal and the second viewpoint signal on the liquid crystal monitor 270 according to the frame sequential system.

1-3-1. Another Example of the Operation for Reproducing (Displaying) Image Signal

The reproducing operation in a case where the flag information representing that the special enhancing process is executed is stored in the headers of the first viewpoint signal and the second viewpoint signal stored in the memory 200 will be described below.

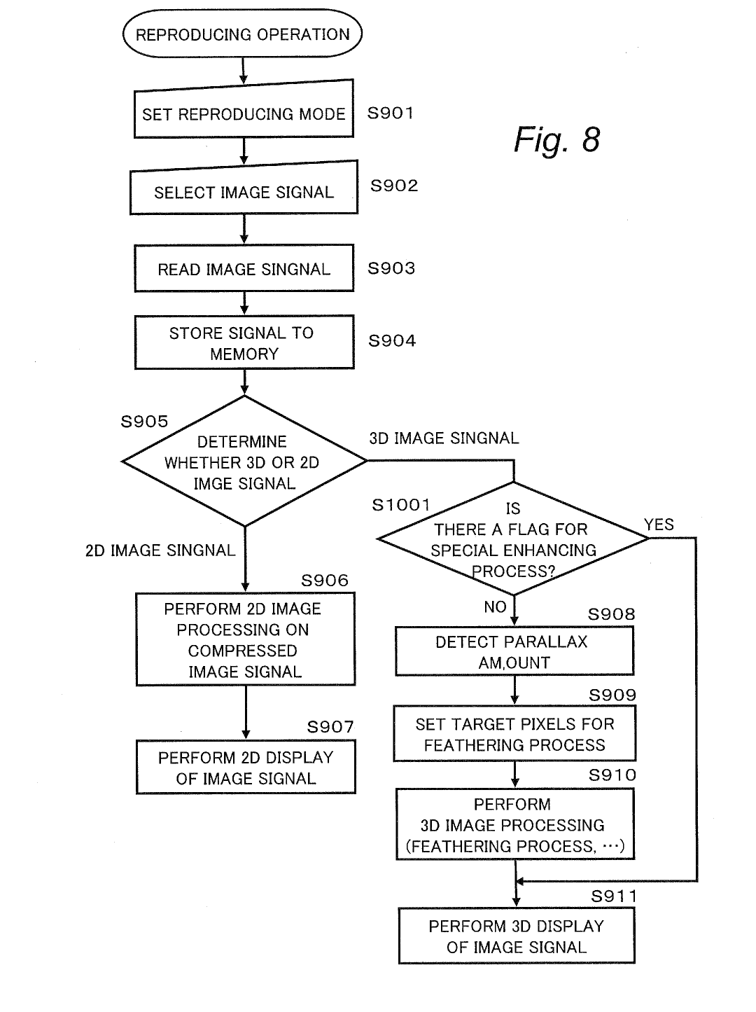

FIG. 8 is a flowchart illustrating the operation for reproducing a compressed image signal, which includes a step (S1001) of detecting the flag information in addition to the steps of the flowchart in FIG. 7.

As shown in FIG. 8, after determining at step S905 that the image signal is the 3D image signal, the controller 210 refers to the flag information and tries to detect the flag information which represents that the special enhancing process is executed in the headers of the first viewpoint signal and the second viewpoint signal (S1001). When the flag information is detected, the sequence goes to step S911, and when the flag information is not detected, the sequence goes to step S908.

1-3-2. Feathering Process

A detailed operation of the feathering process executed by the image processor 160 at step S910 will be described below with reference to the drawings. Hereinafter, the feathering process is realized by the filter process using the low-pass filter.

1-3-2-1. Setting of Filter Coefficient and Filter Size of Low-Pass Filter

The setting of the filter coefficient and the filter size of the low-pass filter used in the feathering process will be described with reference to the drawings.

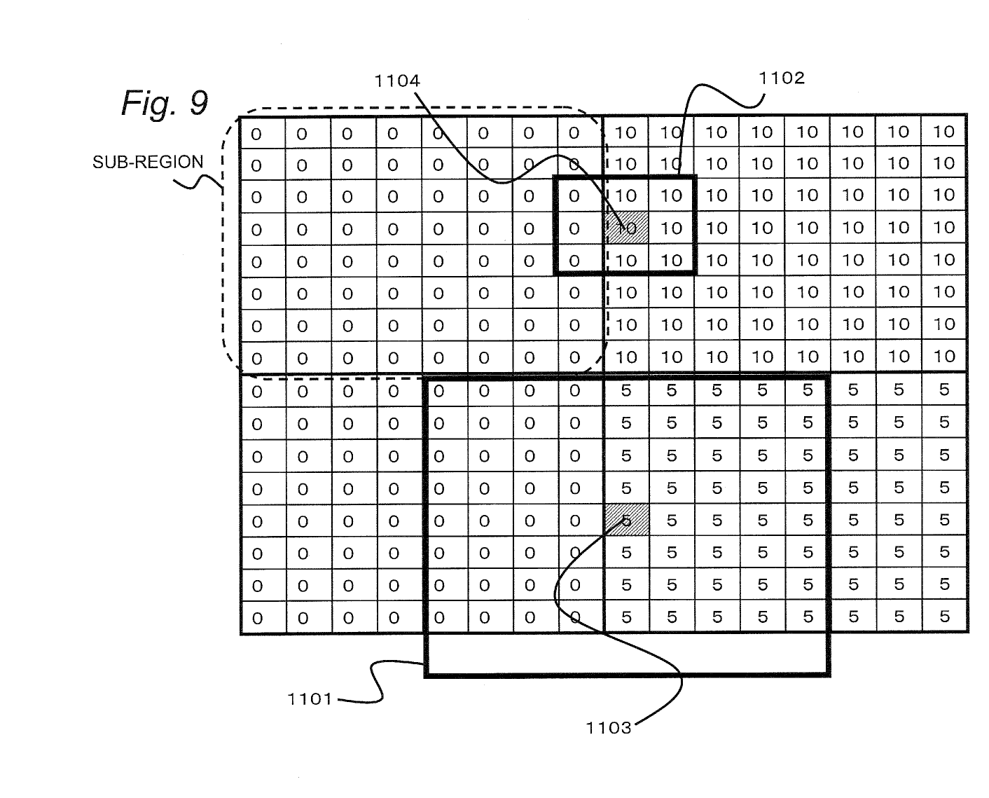

FIG. 9 is a diagram for describing the method for setting the filter size of the low-pass filter based on the amount of parallax.

The image processor 160 sets the filter size according to a display position (namely, the amount of parallax) in the depth direction (the direction vertical to the display screen) of an object included in the first viewpoint signal or the second viewpoint signal at the time of the 3D reproduction. That is to say, the size of the low-pass filter applied to the region visually recognized at the far side from the viewer at the time of the 3D reproduction is set to be smaller than the size of the low-pass filter applied to the region visually recognized at the near side to the viewer. That is to say, outlines of objects displayed on the farther side are displayed more ambiguously. As a result, more natural stereoscopic effect can be reproduced.

Concretely, the image processor 160 calculates a sum of difference in absolute values between the amount of parallax of the target pixel and the amount of parallax of pixels adjacent up, down, right and left to the target pixel. For example, in an example of FIG. 9, the sum of the difference in absolute values on a target pixel 1103 is calculated as 5, and the sum of the difference in absolute values on a target pixel 1104 is calculated as 10. In this case, at the time of the 3D reproduction, the object including the target pixel 1103 is visually recognized at a farther position than the object including the target pixel 1104. Therefore, the image processor 160 sets the size of the low-pass filter 1101 to be larger than the size of the low-pass filter 1102. In the example of FIG. 9, as one example of the filter size, the size of the low-pass filter 1101 is set to 9×9 pixels, and the size of the low-pass filter 1102 is set to 3×3 pixels.

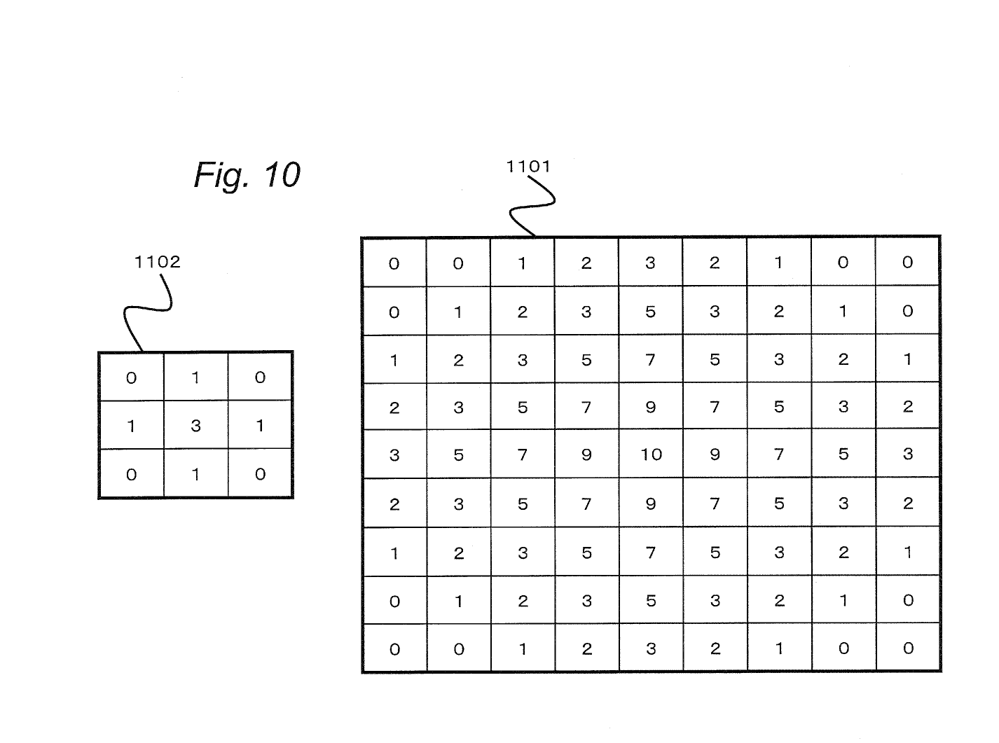

FIG. 10 is a diagram describing the coefficients of the low-pass filter 1101 and the low-pass filter 1102. In this embodiment, as the filter size is larger, the filter coefficient is set to be larger to provide higher feathering effect. For example, the filter coefficient of the large low-pass filter 1101 is set to a value larger than the filter coefficient of the small low-pass filter 1102. That is to say, the low-pass filter 1101 has the larger filter coefficient than the low-pass filter 1102.

With the above configuration of the low-pass filter, objects which are to be visually recognized on farther side at the time of the 3D reproduction are represented by signals indicating more ambiguous image signals, resulting in more natural stereoscopic effect.

1-3-2-2. Setting of Filter Size Based on Correlation in Vertical Direction and Horizontal Direction

The size of the low-pass filter in the image processor 160 may be set by using a correlation between the amount of parallax on the target pixel and the amount of parallax on the pixels adjacent to the target pixel in a vertical direction and a horizontal direction. For example, the amount of parallax on a certain target pixel in the vertical direction is compared with the amount of parallax in the horizontal direction. When the correlation is higher in the vertical direction, the low-pass filter that is long in the horizontal direction is used. On the other hand, when the correlation is higher in the horizontal direction, the low-pass filter that is long in the vertical direction is used. Since the above configuration enables the boundary of the object to be ambiguous more naturally when the first viewpoint signal and the second viewpoint signal are reproduced in 3D reproduction manner, more natural stereoscopic effect can be provided.

The correlation between the target pixel and the pixels adjacent in the horizontal direction and the vertical direction can be determined as follows. For example, a difference absolute value (or absolute value of difference) of the amount of parallax is calculated between the target pixel and each of pixels adjacent to the target pixel in the vertical direction (up-down direction). Then the sum of the difference absolute values is calculated by summing up the absolute values. Similarly, the difference absolute values of the amount of parallax between the target pixel and the pixels adjacent to the target pixel in the horizontal direction (right-left direction) are calculated. Then the sum of the difference absolute values is calculated by summing up the absolute values. The sum of the difference absolute value of the amount of parallax obtained for the pixels adjacent to the target pixel in the vertical direction is compared with the sum of the difference absolute values of the amount of parallax obtained for the pixels adjacent to the target pixel in the horizontal direction. A direction where the sum of the difference absolute values is smaller can be determined as the direction where the correlation is higher.

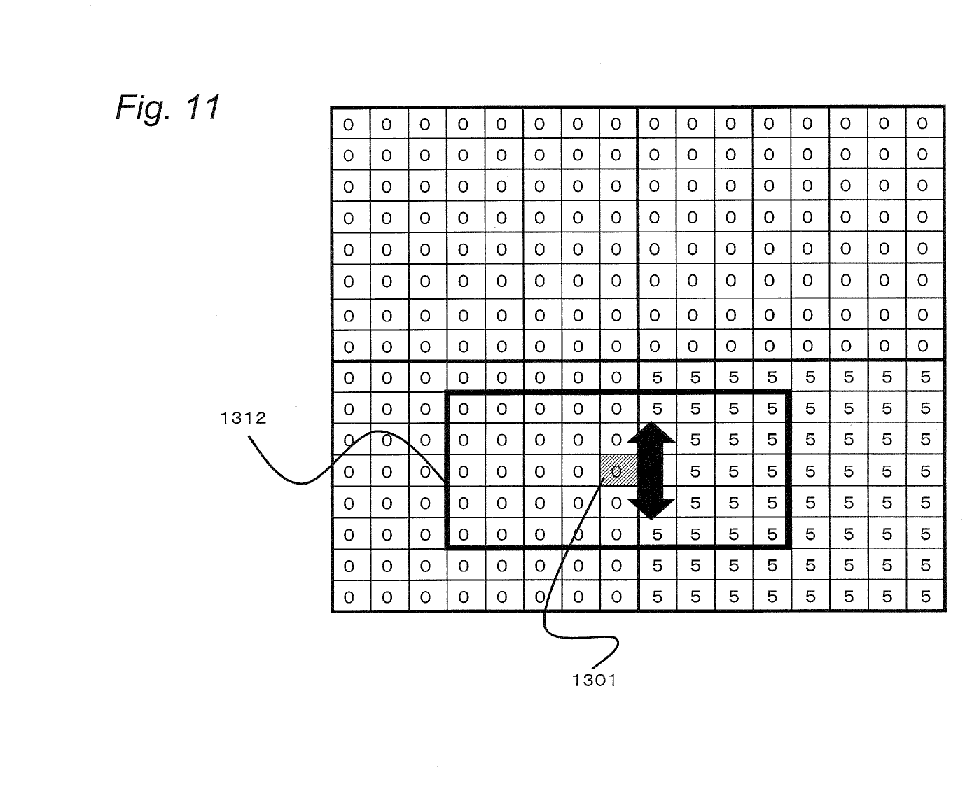

FIG. 11 is a diagram for explaining the operation for setting the filter size in the image processor 160.

The image processor 160 calculates the sum of the difference absolute values of the amount of parallax on the target pixel and the pixels adjacent thereto in the vertical direction and the horizontal direction using the above method. In the example of FIG. 11, regarding a target pixel 1301, the sum of the vertical difference absolute values on the target pixel 1301 in the vertical direction is calculated as 0, and the sum of the horizontal difference absolute values in the horizontal direction is calculated as 5. For this reason, the determination is made that the target pixel 1301 has high correlation in the vertical direction, and a long low-pass filter 1312 which is long in the horizontal direction is set.

The low-pass filters may be prepared for the case where the correlation is higher in the vertical direction and the case where the correlation is higher in the horizontal direction, respectively. The image processor 160 may selectively use the two low-pass filters based on the determined result of the correlation. In this case, the low-pass filter does not have to be set for each edge pixel (the target pixel), so that load amount of the feathering process can be reduced.

Further, as another method for setting the filter size, the following method is present. For example, when an image signal is reproduced in 3D reproduction manner, as a difference on the 3D image in a depth direction defined by one sub-region and other sub-region adjacent to the one sub-region is larger, the filter size of the low-pass filter may be larger. That is to say, a difference between the amount of parallax detected on one sub-region and the amount of parallax detected on other sub-region adjacent to the one sub-region may be obtained as a difference of a position in a depth direction. As the difference is larger, the filter size of the low-pass filter may be larger. As a result, as the difference on the display position in the depth direction at the time of the 3D reproduction is larger, the low-pass filter with larger size is applied so that the higher feathering effect can be obtained.

The methods for setting the filter size and the coefficient described above can be suitably combined.

The above description explained with the flowcharts of FIG. 7 and FIG. 8 refers to the example where the feathering process is executed on the boundary portion of the object at the time of reproducing an image signal. However, the control for executing the feathering process on the boundary portion of the object is not limited to the operation for reproducing an image signal, but can be applied to the operation for recording an image signal. For example, at step S209 in the flowchart of FIG. 2, the feathering process may be executed on pixels which are not targeted for the enhancing process so as to generate the two compressed image signals including the first viewpoint signal and the second viewpoint signal.

### 1-4. Conclusion

As described above, the digital camera 1 executes a signal process for at least one of the first viewpoint signal as an image signal generated at the first viewpoint and the second viewpoint signal as an image signal generated at the second viewpoint. The digital camera 1 is provided with the image processor 160 for executing a predetermined image processing on at least one image signal of the first viewpoint signal and the second viewpoint signal, and the controller 210 for controlling the image processor 160. The controller 210 controls the image processor 160 to perform the feathering process on at least one image signal of the first viewpoint signal and the second viewpoint signal, the feathering process being a process for smoothing pixel values of pixels positioned on a boundary between an object included in a image represented by the at least one image signal, and an image adjacent to the object.

Such configuration causes a boundary portion between an object as a near view and a background image adjacent to the object to be displayed ambiguously, when an image signal is reproduced in 3D reproduction manner, so that unnatural stereoscopic effect which is felt by the viewer, such as the cardboard cut-out effect, can be reduced.

### 2. Second Embodiment

Another embodiment will be described below with reference to the drawings. The image processor 160 described in the first embodiment detects the amount of parallax based on the first viewpoint signal and the second viewpoint signal, and sets a target pixel based on the detected amount of parallax. The amount of parallax corresponds to a display position of an object in a direction (depth direction) vertical to the screen at the time of the 3D reproduction. That is to say, the amount of parallax correlates with a distance to a subject at the time of shooting a 3D image. Therefore, in this embodiment, information about the distance to a subject image is used instead of the amount of parallax. That is to say, the digital camera of the embodiment sets a target pixel based on the information about the distance to the subject image. For convenience of the description, hereinafter, the same components as those in the first embodiment are denoted with the same reference symbols, and their detailed description is omitted.

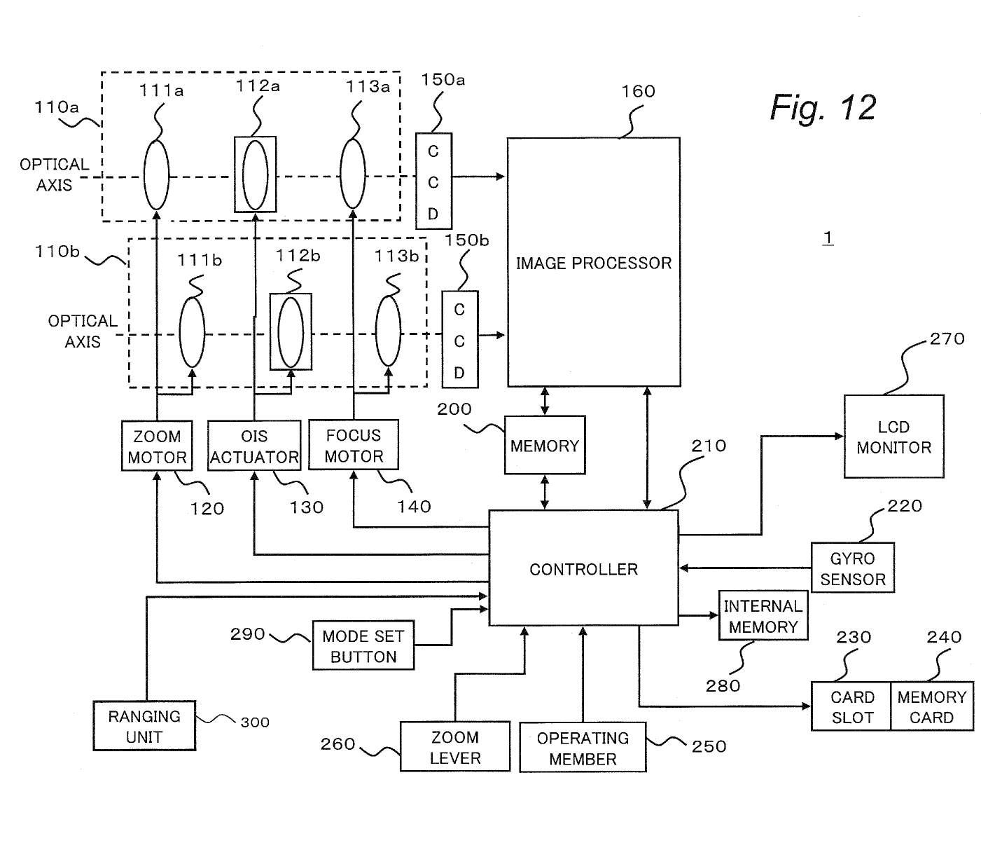

FIG. 12 is a diagram illustrating the digital camera (one example of the 3D image signal processing device) according to a second embodiment. The digital camera 1b of the present embodiment further includes a ranging unit 300 in addition to the configuration described in the first embodiment. In the operation relating to the ranging unit 300, the operation of the image processor 160b in the second embodiment is different from that in the first embodiment. The other operations and the configuration are the same as those in the first embodiment.

The ranging unit 300 has a function for measuring a distance from the digital camera 2 to a subject to be shot. For example, the ranging unit 300 emits an infrared signal and measures a reflected signal of the emitted infrared signal so as to measure the distance. The ranging unit 300 may be configured to be capable of measuring a distance for each sub-region according to the first embodiment or for each pixel. For convenience of the description, hereinafter, the ranging unit 300 can measure a distance for each sub-region. A ranging method in the ranging unit 300 is not limited to the above method, and any method may be used which is used generally.

The ranging unit 300 measures a distance to a subject for each sub-region at the time of shooting the subject. The ranging unit 300 outputs information about the distance which is measured for each sub-region to the image processor 301. The image processor 301 generates a distance image (depth map) using the information about the distance. Use of the distance information for each sub-region obtained from the distance image instead of the amount of parallax on each sub-region according to the first embodiment allows a target pixel to be set, similarly to the first embodiment.

In this manner, the digital camera 2 in this embodiment can set a target pixel that is not subject to the enhancing process or is subject to the feathering process, based on the distance information on each sub-region obtained by the ranging unit 300. For this reason, unlike the first embodiment, a target pixel can be set without executing a process for detecting the amount of parallax from the first viewpoint signal and the second viewpoint signal. Further, the distance information can be used instead of the amount of parallax, to set the size and the coefficient of the low-pass filter, similarly to the first embodiment.

### 3. Other Embodiment

The ideas of the first embodiment and the second embodiment may be suitably combined. Further, an idea described below may be suitably combined with the idea of the first embodiment and/or the idea of the second embodiment.

(1) Utilization of Angle of Convergence

When the image processor 160 can recognize a viewing environment in which the first viewpoint signal and the second viewpoint signal are to be reproduced in 3D reproduction manner, the image processor 160 may set an angle of convergence detected on a sub-region as the amount of parallax.

It is assumed that an angle of convergence on a certain sub-region is detected as α, and an angle of convergence of the sub-region B adjacent to the certain sub-region is detected as β. In general, it is known that comfortable stereoscopic effect can be recognized between the two sub-regions when a difference (α−β) is within 1°.

According to the above fact, the image processor 160 may set a pixel positioned on a boundary portion between a sub-region A and a sub-region B, as a target pixel, when, for example, (α−β) is within a predetermined value (for example, 1°).

(2) As to the method for setting the low-pass filter to be used in the feathering process, the following setting method is also considered. The following setting method can be used in suitable combination with the aforementioned method for setting the low-pass filter.

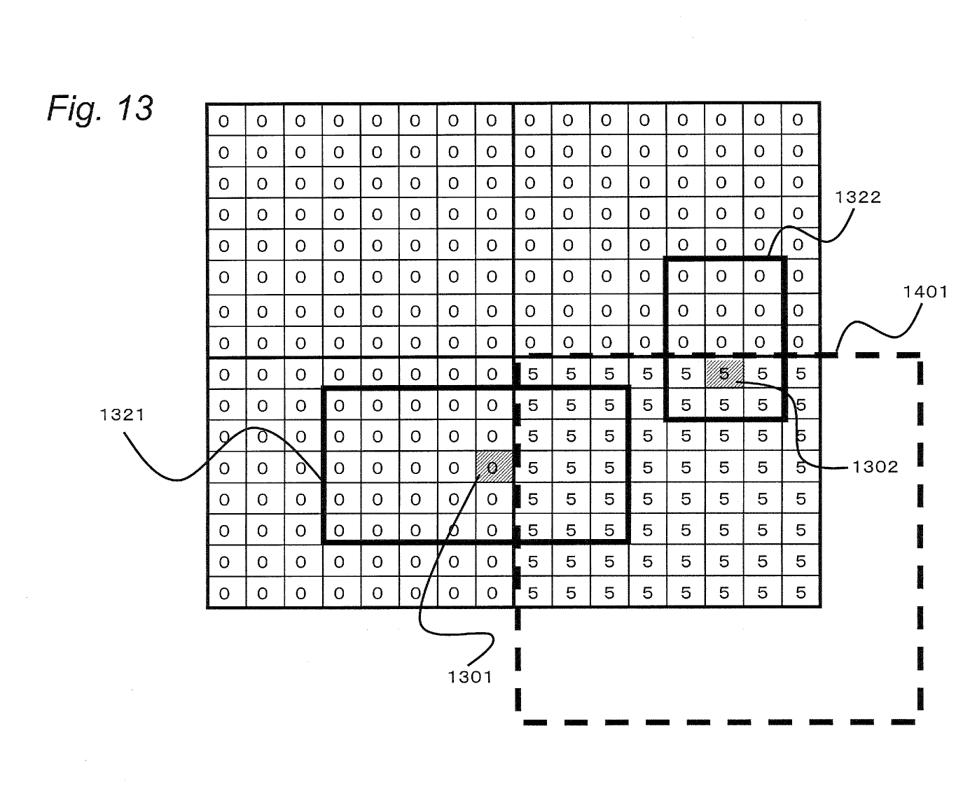

i) A size of a filter applied outside an object (sub-region as the target for the enhancing process) may be set to be larger than a size of a filter applied inside the object. For example, like the low-pass filters 1321 or 1322 to be applied to the target pixel 1301 or 1302 as shown in FIG. 13, a size of a filter portion applied to the outside portion of the object 1401 is set to be larger than a size of a filter portion applied to the inside portion of the object 1401. This arrangement can provide the feathering effect on which image information about the outside portion of the object is reflected more.

ii) Setting of Low-Pass Filter in View of Occlusion

When there is occlusion in an image, the filter size and the coefficient of the low-pass filter may be preferably set as follows.

That is to say, when an object is included in either one of the image represented by the first viewpoint signal and the image represented by the second viewpoint signal, the filter size of the low-pass filter applied to a region of one image including the object is preferably set to be larger than the filter size of the low-pass filter applied to a corresponding region in the other image. In another manner, the coefficient of the low-pass filter applied to the region in the one image including the object is set to strengthen the feathering effect. In general, when occlusion is present, flicker becomes a problem during the 3D reproduction. Therefore, setting the filter size and the coefficient in such a manner allows the flicker to be reduced. The image processor 160 can detect presence of occlusion by performing block matching per sub-region on both the image represented by the first viewpoint signal and the image represented by the second viewpoint signal.

iii) Setting of Low-Pass Filter According to Screen Size of Display Device

The digital camera 1 obtains a screen size of a display device and may change the size of the low-pass filter according to the obtained screen size. In this case, as a screen size is smaller, the filter size of the low-pass filter to be applied is made smaller, or the coefficient is made smaller (set so that the feathering effect becomes lower). The screen size of a display device can be obtained from the display device via, for example, HDMI (High Definition Multimedia Interface). In another manner, the screen size of the display device may be set in the digital camera 1 by the user in advance. Alternatively, the screen size of the display device may be added as additional information to shot image data. In general, when the display screen is small such as the liquid crystal monitor provided on a back of the digital camera, the stereoscopic effect is reduced. Therefore, by setting the filter size of the low-pass filter (or coefficient) smaller as the screen size is smaller, the strength of the feathering process can be reduced according to the size of the display screen, so that a level of reduction in the stereoscopic effect visually recognized by the viewer can be reduced.

(3) In the digital camera described in the embodiments, each block may be configured as one chip individually by a semiconductor device such as LSI, or some or all of the blocks may be configured as one chip. LSI is occasionally called IC, system LSI, super LSI or ultra LSI according to a difference of an integration degree.

A method for an integration of circuit is not limited to LSI, and may be realized by an exclusive-use circuit or a general-purpose processor. After manufacturing of LSI, FPGA (Field Programmable Gate Array) that can be programmed, or a reconfigurable processor that enables connection and setting of a circuit cell in LSI to be reconfigured may be used.

Further, when a technique for an integration of circuit that can replace LSI would appear due to development of semiconductor techniques or another derived techniques, naturally the functional blocks may be integrated by using such techniques. Biotechniques can be applied.

(4) The respective processes in the above embodiments may be realized by hardware or by software solely. Alternatively, the processes may be realized by a cooperating process of software and hardware. When the digital camera according to the above embodiments is realized by hardware, it goes without saying that timing for executing the respective processes should be adjusted. In the above embodiment, for convenience of description, details of the timing adjustment of various signals caused by actual hardware design are omitted.

(5) An order of executing the processes described in the above embodiments is not necessarily limited to the order disclosed in the embodiments. It goes without saying that the processes can be randomly executed without departing from the scope of the present invention.

(6) It goes without saying that the concrete configuration of the present invention is not limited to the contents disclosed in the embodiments, and a person skilled in the art can make various modifications and corrections without departing from the scope of the present invention.

### INDUSTRIAL APPLICABILITY

The present invention can generate an image signal for providing more natural stereoscopic effect during 3D reproduction. Thus the present invention can be applied to a digital camera, and a broadcasting camera, which can shoot 3D images, and a recorder or a player which can record/reproduce 3D images.

### REFERENCE SIGNS

110a, 110b Optical system
120a, 120b Zoom motor
130a, 130b OIS actuator
140a, 140b Focus motor
150a, 150b CCD image sensor
160 Image processor
200 Memory
210 Controller
220 Gyro sensor
230 Card slot
240 Memory card
250 Operating member
260 Zoom lever
270 Liquid crystal monitor
280 Internal memory
290 Mode setting button
300 Ranging unit
701, 702 Region
801 Target pixel
1101, 1102 Low pass filter
1103, 1104 Target pixel for filtering process

1. A 3D image signal processing device for performing a signal processing on at least one image signal of a first viewpoint signal as an image signal generated at a first viewpoint and a second viewpoint signal as an image signal generated at a second viewpoint different from the first viewpoint, the device comprising:
an image processor that executes a predetermined image processing on at least one image signal of the first viewpoint signal and the second viewpoint signal; and
a controller that controls the image processor,
wherein the controller controls the image processor to perform an feathering process on at least one image signal of the first viewpoint signal and the second viewpoint signal, the feathering process being a process for smoothing pixel values of pixels positioned on a boundary between an object included in the image represented by the at least one image signal and an image adjacent to the object.

2. The 3D image signal processing device according to claim 1, further comprising a parallax amount obtaining unit that obtains an amount of parallax between an image represented by the first viewpoint signal and an image represented by the second viewpoint signal on each of sub-regions which are obtained by dividing a region of the image represented by the at least one image signal,
wherein the controller controls the image processor to perform the feathering process on pixel data of pixels positioned on a boundary between one sub-region and another sub-region adjacent to the one sub-region based on the amount of parallax detected on the one sub-region and the amount of parallax detected on the another sub-region.

3. The 3D image signal processing device according to claim 2, wherein the controller
calculates a difference in positions in a depth direction on the 3D image, at which the one sub-region and the another sub-region are displayed in 3D reproduction manner during reproducing, as a 3D image, the first viewpoint signal and the second viewpoint signal, based on the detected amount of parallax, and
controls the image processor according to the calculated result to perform the feathering process on the pixel data of pixels positioned on the boundary between the one sub-region and the another sub-region.

4. The 3D image signal processing device according to claim 2, wherein
the image processor performs the feathering process using a low-pass filter,
the image processor switches a filter size of the low-pass filter according to a difference between the amount of parallax detected on the one sub-region and the amount of parallax detected on the another sub-region.

5. The 3D image signal processing device according to claim 4, wherein when a difference between the amount of parallax detected on the one sub-region and the amount of parallax detected on the sub-region adjacent in a vertical direction to the one sub-region is smaller than a difference between the amount of parallax detected on the one sub-region and the amount of parallax detected on the sub-region adjacent in a horizontal direction to the one sub-region, the image processor performs the feathering process using a low-pass filter in which a size in the horizontal direction is larger than a size in the vertical direction.

6. The 3D image signal processing device according to claim 4, wherein when a difference between the amount of parallax detected on the one sub-region and the amount of parallax detected on the sub-region adjacent in a horizontal direction to the one sub-region is smaller than a difference between the amount of parallax detected on the one sub-region and the amount of parallax detected on the sub-region adjacent in a vertical direction to the one sub-region, the image processor performs the feathering process using a low-pass filter in which a size in the vertical direction is larger than a size in the horizontal direction.

7. The 3D image signal processing device according to claim 4, wherein as the difference between the amount of parallax detected on the one sub-region and the amount of parallax detected on the another sub-region is larger, a filter size of the low-pass filter used in the image processor is set to be larger.

8. The 3D image signal processing device according to claim 1, further comprising:
an obtaining unit that obtains information about a position of the object in a depth direction during 3D reproduction in each of sub-regions obtained by dividing the region of the image represented by the at least one image signal, wherein
the image processor performs the feathering process using the low-pass filter,
the image processor switches the filter size of the low-pass filter according to the position in the depth direction during 3D reproduction of the object.

9. The 3D image signal processing device according to claim 1, further comprising:
a recording medium which stores the first viewpoint signal and the second viewpoint signal, which are related to each other; and
a reading unit that reads the first viewpoint signal and the second viewpoint signal from the recording medium,
wherein when the first viewpoint signal and the second viewpoint signal are read from the reading unit in order to achieve 3D display, the controller controls the feathering processor to perform the feathering process on at least one of the first viewpoint signal and the second viewpoint signal.

10. The 3D image signal processing device according to claim 1, further comprising:
a recording medium which stores the first viewpoint signal and the second viewpoint signal, which are related to each other; and
a reading unit that reads the first viewpoint signal and the second viewpoint signal from the recording medium,
wherein when either one of the first viewpoint signal and the second viewpoint signal is read from the reading unit, the controller controls the feathering processor to not perform the feathering process on the read image signal.

11. The 3D image signal processing device according to claim 1, further comprising:
a distance information obtaining unit that obtains information about a distance of a subject included in each of sub-regions, the sub-regions being obtained by dividing the image represented by the at least one image signal,
wherein the controller controls the image processor to perform the feathering process on pixel data of pixels positioned on a boundary between one sub-region and another sub-region adjacent to the one sub-region according to a difference between a distance of a subject included in the one sub-region and a distance of the subject included in the another sub-region.

12. A 3D image recording device for capturing a subject to generate a first viewpoint signal and a second viewpoint signal, the device comprising:
a first optical system that forms a subject image at a first viewpoint;
a second optical system that forms a subject image at a second viewpoint different from the first viewpoint;
an imaging unit that generates the first viewpoint signal from the subject image at the first viewpoint and the second viewpoint signal from the subject image at the second viewpoint;
an enhancing processor that performs an enhancing process on the first viewpoint signal and the second viewpoint signal;
a recording unit that records the first viewpoint signal and the second viewpoint signal that are subject to the enhancing process in a recording medium; and
a controller that controls the enhancing processor and the recording unit,
wherein the controller controls the enhancing processor so that strength of the enhancing process in a case where the first viewpoint signal and the second viewpoint signal are generated as 3D image signal is weaker than strength in a case where those signals are generated as 2D image signal.

13. A 3D image recording device for capturing a subject to generate a first viewpoint signal and a second viewpoint signal, the device comprising:
a first optical system that forms a subject image at a first viewpoint;
a second optical system that forms a subject image at a second viewpoint different from the first viewpoint;
an imaging unit that generates the first viewpoint signal from the subject image at the first viewpoint and the second viewpoint signal from the subject image at the second viewpoint;
a parallax amount obtaining unit that obtains an amount of parallax between an image represented by the first viewpoint signal and an image represented by the second viewpoint signal for each of sub-regions, the sub-regions being obtained by dividing a region of the image represented by at least one image signal of the first viewpoint signal and the second viewpoint signal;
an enhancing processor that performs an enhancing process on the first viewpoint signal and the second viewpoint signal;
a recording unit that records the first viewpoint signal and the second viewpoint signal that are subject to the enhancing process in a recording medium; and
a controller that controls the enhancing processor and the recording unit,
wherein when the first viewpoint signal and the second viewpoint signal are generated as 3D image signal, the controller controls the enhancing processor to perform the enhancing process on pixels other than pixels positioned on a boundary between one sub-region and another sub-region adjacent to the one sub-region according to a difference between the amount of parallax detected on the one sub-region and an amount of parallax detected on the another sub-region.

14. A 3D image signal processing method for performing a signal processing on at least one image signal of a first viewpoint signal as an image signal generated at a first viewpoint and a second viewpoint signal as an image signal generated at a second viewpoint different from the first viewpoint, the method comprising:
performing, on at least one image signal of the first viewpoint signal and the second viewpoint signal, a process for smoothing pixel values of pixels positioned on a boundary between an object included in the image represented by the at least one image signal and an image adjacent to the object.

15. The 3D image signal processing method according to claim 14, further comprising:
obtaining an amount of parallax between an image represented by the first viewpoint signal and an image represented by the second viewpoint signal on each of sub-regions obtained by dividing a region of the image represented by the at least one image signal,
wherein the smoothing process is performed on pixel data of pixels positioned on a boundary between one sub-region and another sub-region adjacent to the one sub-region based on the amount of parallax detected on the one sub-region and the amount of parallax detected on the another sub-region.

16. A 3D image recording method for recording a first viewpoint signal and a second viewpoint signal generated by capturing a subject in a recording medium, the method comprising:
generating the first viewpoint signal from a subject image at a first viewpoint, and generating the second viewpoint signal from a subject image at a second viewpoint different from the first viewpoint;
performing an enhancing process on the first viewpoint signal and the second viewpoint signal; and
recording the first viewpoint signal and the second viewpoint signal that are subject to the enhancing process in the recording medium,
wherein in the enhancing process, strength of the enhancing process in a case where the first viewpoint signal and the second viewpoint signal are generated as 3D image signal is weaker than strength in a case where those signals are generated as 2D image signal.

17. A 3D image recording method for recording a first viewpoint signal and a second viewpoint signal generated by capturing a subject in a recording medium, the method comprising:
generating the first viewpoint signal from a subject image at a first viewpoint and the second viewpoint signal from a subject image at a second viewpoint different from the first viewpoint;
performing an enhancing process on the first viewpoint signal and the second viewpoint signal; and
recording the first viewpoint signal and the second viewpoint signal that are subject to the enhancing process in the recording medium; and
obtaining an amount of parallax between an image represented by the first viewpoint signal and an image represented by the second viewpoint signal for each of sub-regions, the sub-regions being obtained by dividing a region of the image represented by at least one image signal of the first viewpoint signal and the second viewpoint signal,
wherein when the first viewpoint signal and the second viewpoint signal are generated as 3D image signal, the enhancing process is applied on pixels other than pixels positioned on a boundary between one sub-region and another sub-region adjacent to the one sub-region according to a difference between the amount of parallax detected on the one sub-region and an amount of parallax detected on the another sub-region.
